(19) United States
(12) Patent Application Publication
(10) Pub. No.: US 2025/0046557 A1
(43) Pub. Date: Feb. 6, 2025

(54) ELECTRICAL PROTECTION DEVICE CONFIGURED TO AUTOMATICALLY DETERMINE A CAUSE OF AN ELECTRICAL CIRCUIT OPENING AND ASSOCIATED METHOD

(71) Applicant: Schneider Electric Industries SAS, Rueil Malmaison (FR)

(72) Inventor: Thomas Pupin, Seyssinet Pariset (FR)

(73) Assignee: Schneider Electric Industries SAS, Rueil Malmaison (FR)

(21) Appl. No.: 18/785,128

(22) Filed: Jul. 26, 2024

(30) Foreign Application Priority Data
Aug. 2, 2023 (FR) 2308369

(51) Int. Cl. H01H 83/22; H01H 71/02; H01H 71/04; H01H 71/08; H01H 71/14; H01H 71/24; H01H 71/52; H01H 73/06; H01H 73/48

(52) U.S. Cl. CPC H01H 83/226; H01H 71/0228; H01H 71/04; H01H 71/08; H01H 71/526; H01H 73/06; H01H 73/48; H01H 71/14; H01H 71/24

(57) ABSTRACT

An electrical protection device, including a movable contact, connected to an electrical circuit, a switching handle, and an electronic control unit. The device further includes an electrical link element, connecting the movable contact and the electronic control unit, a switch, a mechanical link element, connected to the switching handle. The electronic control unit is configured to measure the first voltage and the second voltage, compare the first voltage and the second voltage to determine the cause of opening of the electrical circuit among manual opening and fault opening, send a first signal if the cause of opening is manual opening and send a second and/or third signal if the cause of opening is fault opening.

### TECHNICAL FIELD

The present invention relates to an electrical protection device configured to automatically determine a cause of an electrical circuit opening and to an associated method.

The invention is particularly applicable to the field of miniature circuit breakers (MCBs) that are used to protect low-voltage electrical installations.

### BACKGROUND

Many electrical protection devices, in addition to being opened when an electrical fault is detected, which causes an electrical circuit in which said electrical protection devices are connected to open, may be opened manually by a user, for example by actuation of a handle. It may be advantageous to distinguish between opening by a user and opening caused by an electrical fault. To this end, it is known practice to add an additional accessory, for example an additional module, to already existing protection devices, allowing this distinction of the cause of opening.

However, this increases the bulk of the electrical protection device, and complicates the installation of the device, since the module must be installed and connected to the rest of the electrical protection device.

### SUMMARY

The object of the invention is then to solve these drawbacks and to propose an electrical protection device that makes it possible to distinguish the cause of opening and that is compact and easy to install.

To this end, the invention relates to an electrical protection device that is designed to be connected between an input conductor and an output conductor of an electrical circuit, and to open the electrical circuit upon manual command or following detection of an electrical fault, the device being further configured to automatically determine a cause of opening of the electrical circuit, the device comprising:
a movable contact that is connected to the electrical circuit and is movable between:
   a conducting position, in which the movable contact closes the electrical circuit, and
   an isolating position, in which the movable contact opens the electrical circuit;
a switching handle that is movable between an open position and a closed position, the movement of the switching handle to the open position by manual control causing the movable contact to be placed into the isolating position;
a switching mechanism that is configured to toggle between an armed configuration, in which the movable contact is in the conducting position and the switching handle is in the closed position, and a tripped configuration, in which the movable contact is in the isolating position and the switching handle is in the open position;
a tripping device that is configured to actuate the switching mechanism in the event of detecting an electrical fault to command the tripped configuration;
an electronic control unit.

According to the invention, the device further comprises:
an electrical link element that connects the movable contact and the electronic control unit, and is configured so that a first current flows through the electrical link element to the electronic control unit, a first voltage being representative of the position of the movable contact in the conducting position or in the isolating position;
a switch that is connected to the electronic control unit and is movable between a depressed position and a free position, and is configured so that a second current flows through the switch to the electronic control unit, a second voltage being representative of the position of the switch between the depressed position and the free position;
a mechanical link element that is connected to the switching handle and movable between:
   a pressing position, the mechanical link element then pressing the switch and holding it in the depressed position, and
   a releasing position, the mechanical link element then releasing the switch which toggles to the free position,
and the electronic control unit is configured to measure the first voltage and the second voltage, compare the first voltage and the second voltage to determine the cause of opening of the electrical circuit among manual opening and fault opening, send a first signal if the cause of opening is manual opening and send a second and/or third signal if the cause of opening is fault opening.

By virtue of the invention, the electrical protection device integrates the ability to determine the cause of opening of a circuit, and to distinguish manual opening from opening caused by an electrical fault, without adding an additional module, this function being directly integrated into the housing of the device. The invention therefore makes it possible to reduce the bulk of devices integrating this ability to determine a cause of opening. By virtue of the invention, it is also not necessary to mount an additional module or to connect it to the electrical protection device, which facilitates installation.

According to other advantageous aspects of the invention, the electrical protection device comprises one or more of the following features, taken alone or in any technically possible combinations:
The movable contact is a movable phase contact.
The mechanical link element is in the pressing position when the switching handle is in the closed position and in the releasing position when the switching handle is in the open position.
The electrical link element is a spring that is in contact with the movable contact when the movable contact is in the conducting position and is separated from the movable contact when the movable contact is in the isolating position, one of the ends of the electrical link element being connected to the electronic control unit.
The mechanical link element is a link rod that is connected to the switching handle, and one end of which is configured to press or release the switch.
The device further comprises a thermal tripping device and/or a magnetic tripping device that is configured to toggle the movable contact from the conducting position to the isolating position when the thermal tripping device and/or the magnetic tripping device is excited by an electrical fault of short-circuit or overload type.
The device is integrated into a housing, the housing having a width, measured in a width direction, of less than 20 mm, preferably equal to or less than 18 mm.

The invention also relates to a method for automatically determining a cause of opening of an electrical circuit, the method being implemented by the device described above, the method comprising:
measuring the first voltage and the second voltage;
comparing the first voltage with a first voltage threshold;
when the first voltage falls below the first voltage threshold, measuring a duration between a moment when the first voltage falls below the first voltage threshold, and a moment when the second voltage falls below a second voltage threshold;
comparing the duration with a duration threshold;
sending the first signal when the duration is less than the duration threshold, the first signal corresponding to manual opening;
sending the second signal and/or the third signal when the duration is greater than or equal to the duration threshold, the second signal and/or the third signal corresponding to fault opening.

According to other advantageous aspects of the invention, the method comprises one or more of the following features, taken alone or in any technically possible combinations:
The method comprises sending the second signal when the duration is greater than or equal to the duration threshold and when an intensity value of a current is less than a current threshold, the method further comprising sending the third signal when the duration is greater than or equal to the duration threshold and the intensity value of the current is greater than or equal to the current threshold.
The duration threshold is less than 10 ms, preferably equal to 6 ms.
The current threshold is equal to a nominal current flowing through the electrical circuit multiplied by a predetermined value, for example three.
The method further comprises sending a fourth signal when the duration is greater than or equal to a network fault duration threshold, the network fault duration threshold being greater than the duration threshold.

### BRIEF DESCRIPTION OF THE DRAWINGS

The invention will become more clearly apparent upon reading the following description, given solely by way of non-limiting example and with reference to the drawings, in which:

FIG. 1 is a view of an electrical protection device according to the invention, from a first angle, shown in a closed configuration;

FIG. 2 is a view of the electrical protection device of FIG. 1, from a second angle;

FIG. 3 is a view of the detail Ill of FIG. 1;

FIG. 4 is a view similar to that of FIG. 3, the electrical protection device being in an open configuration;

FIG. 5 is a flow chart of a method according to the invention according to one embodiment; and

FIG. 6 shows, on two inserts a) and b), a graph representing a variation of a first voltage and a second voltage in the protection device of FIG. 1, in the case of manual opening and in the case of fault opening.

### DETAILED DESCRIPTION

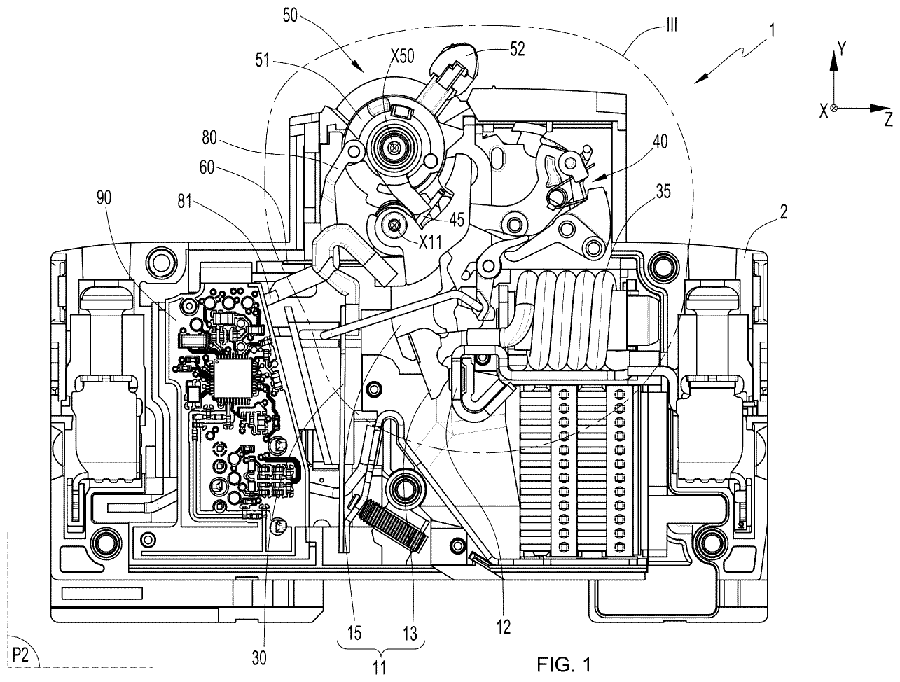

The electrical protection device is described below with reference to FIGS. 1 to 4.

FIG. 1 shows a view from a first angle of an electrical protection device 1, also called a device 1 according to the invention. In FIG. 1, this electrical protection device 1 is a circuit breaker, in this case a miniature circuit breaker (MCB), but the invention may also be applied to other types of circuit breakers, or to other electrical devices intended to protect electrical installations and/or people. In this case, the device 1 protects electrical installations against abnormal conditions, in particular short circuits and current overloads. The device 1 is more particularly intended to be used to protect electrical installations at low voltage, for example voltages of less than or equal to 1000 V AC. For this purpose, when the device 1 is in operation, it is connected to an electrical circuit, more precisely between an input conductor and an output conductor of the electrical circuit, which are not shown in the figures. The input conductor is, for example, a busbar and the output conductor is, for example, an electrical cable.

A width direction X, a depth direction Y and a height direction Z are defined, which are perpendicular to one another and which are fixed with respect to the device 1. The width direction X is horizontal and normal to the plane of FIGS. 1 to 4.

The device 1 comprises a housing 2, which is essentially closed and contains the majority of the other elements of the device 1. The housing 2 is formed of an electrically insulating material. The directions X, Y and Z are fixed with respect to the housing 2.

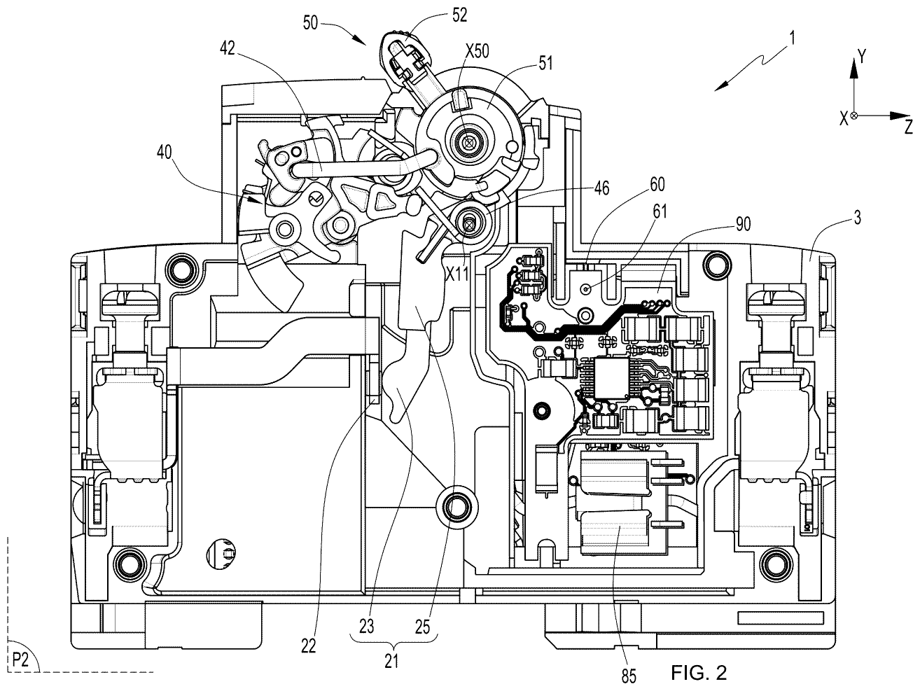

In FIG. 1, only a part of the housing 2 is visible, namely a half-shell. The housing 2 comprises another half-shell 3 that is visible in FIG. 2 and is essentially symmetrical to the one shown, with respect to a plane P2 that delimits the half-shell 2 on its side.

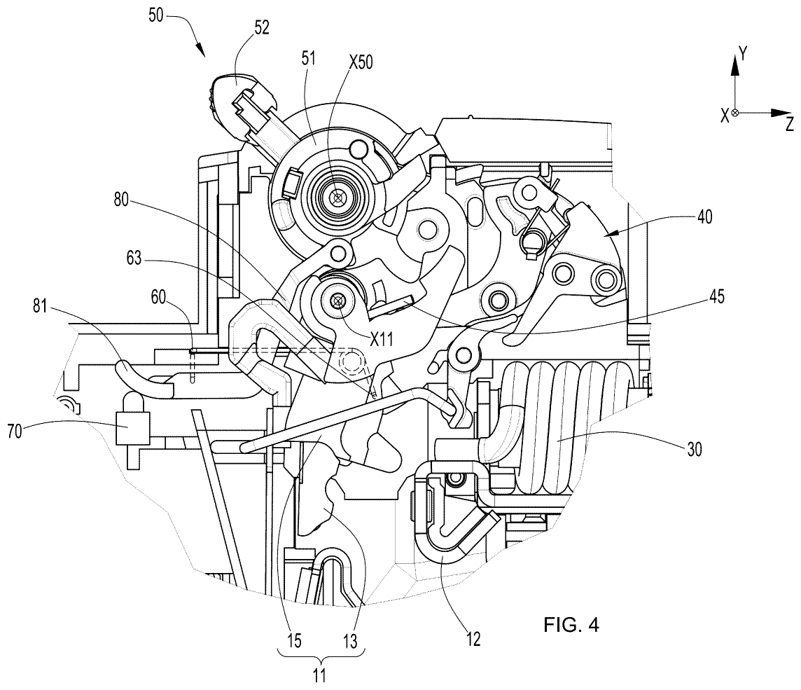

The device 1 comprises a movable contact 11 and a fixed contact 12. The movable contact 11 is generally referred to as the movable phase contact 11, and the fixed contact 12 is generally referred to as the fixed phase contact 12. The fixed contact 12 is fixed with respect to the housing 2 and is connected to the input conductor of the electrical circuit. The movable contact 11 is connected to the output conductor of the electrical circuit and is situated facing the fixed contact 12 in the height direction Z. The movable contact 11 preferably comprises a conductive end 13, performing the function of an electrical contact. The movable contact 11 preferably comprises a contact carrier 15, which carries the conductive end 13. The movable contact 11 is able to pivot, with respect to the housing 2, by way of the contact carrier 15, about a movable contact axis X11, parallel to the width direction X. This pivoting is effected between a conducting position, shown in FIG. 1, and an isolating position, shown in FIG. 4. In the conducting position of the movable contact 11, the conductive end 13 is in electrical contact with, and bearing against, the fixed contact 12, allowing the current to flow between the input conductor and the output conductor of the electrical circuit. In other words, in the conducting position, the movable phase contact 11 closes the electrical circuit. In the isolating position, the conductive end 13 of the movable contact 11 is spaced apart from the fixed contact 12 so as to be electrically isolated therefrom. In other words, in the isolating position, the movable phase contact 11 opens the electrical circuit.

The electrical protection device 1 advantageously comprises a second movable contact 21 and a second fixed contact 22, which are visible in FIG. 2. The second movable contact 21 is generally referred to as the movable neutral contact 21 and the second fixed contact 22 is generally referred to as the fixed neutral contact 22. The fixed neutral contact 22 is connected to the input conductor of the electrical circuit. The movable neutral contact 21 is connected to the output conductor of the electrical circuit. The movable neutral contact 21 preferably comprises a conductive end 23 and a contact carrier 25 in a similar manner to that described for the movable phase contact 11. The movable neutral contact 21 is able to pivot, with respect to the housing 2, about the axis X11, that is to say about the same axis as that of the movable contact 11. However, in a variant, provision could be made for the movable phase contact 11 and the movable neutral contact 21 to pivot about two distinct, preferably mutually parallel, axes. The pivoting of the movable neutral contact 21 is effected between a conducting position and an isolating position. Similarly to the movable phase contact 11, in the conducting position of the movable neutral contact 21, the conductive end 23 is in electrical contact with, and bearing against, the fixed neutral contact 22. In other words, in the conducting position, the movable neutral contact 21 closes the electrical circuit. In the isolating position, the conductive end 23 of the movable neutral contact 21 is spaced apart from the fixed neutral contact 22 so as to be electrically isolated therefrom. In other words, in the isolating position, the movable neutral contact 21 opens the electrical circuit.

The movable phase contact 11 and the movable neutral contact 21 are advantageously able to pivot independently with respect to the housing 2. When they move from their respective isolating positions into their respective conducting positions, the movable phase contact 11 and the movable neutral contact 21 advantageously rotate in the same direction. In particular, the conductive ends 13 and 23 are then displaced essentially in a direction opposite to the Z direction. When the movable phase contact 11 and the movable neutral contact 21 are in the conducting position, the electrical circuit is closed, and electric current flows through the fixed phase contact 12 to the movable phase contact 11, and through the fixed neutral contact 22 to the movable neutral contact 21.

The electrical protection device 1 further comprises at least one tripping device. In the example illustrated, two tripping devices are shown, which are configured so as to each be excited by an electrical fault of a distinct respective predetermined type. Each tripping device is designed to individually trip the movable phase contact 11 and the movable neutral contact 21 into an isolating position when one of the tripping devices is excited. In this case, one of the tripping devices is a thermal tripping device 30 and is designed to be excited by a predetermined electrical fault of current overload type. The other tripping device is a magnetic tripping device 35 and is designed to be excited by a short circuit. Such tripping devices 30 and 35 are known per se and are not described in greater detail.

As an option, which is not shown, the device 1 comprises an additional tripping device that is configured to be excited by another electrical fault of a predetermined type, namely an electrical fault of differential type. The device 1 is then what is known as an RCBO (residual current breaker with overcurrent protection) circuit breaker.

The electrical protection device 1 also comprises a switching mechanism 40.

The switching mechanism 40 is housed in the housing 2. The switching mechanism 40 is configured to toggle between an armed configuration, shown in FIG. 1, in which the switching mechanism 40 places the movable phase contact 11 and the movable neutral contact 21 into the conducting position, and a tripped configuration, partially shown in FIG. 4, in which the switching mechanism 40 places the movable phase contact 11 and the movable neutral contact 21 into the isolating position.

A first contact spring 45 bears against the first movable contact 11, in particular against the contact carrier 15, and against the switching mechanism 40. A second contact spring 46 bears against the second movable contact 21, in particular against the contact carrier 25, and against the switching mechanism 40. The contact springs 45 and 46 are helical torsion springs. Provision is made for the first and second contact springs 45 and 46 to apply, to the movable phase contact 11 and the movable neutral contact 21, respectively, a torque about the axis X11, which tends to make the movable phase contact 11 and the movable neutral contact 21 bear against the fixed phase contact 12 and the fixed neutral contact 22.

The electrical protection device 1 also comprises a switching handle 50. The switching handle 50 is designed to be actuated by a user, between an open position and a closed position and vice versa. The switching handle 50 is able to pivot with respect to the housing 2, about a handle axis X50, parallel to the direction X, between a closed position that is shown in FIGS. 1 to 3, and an open position that is shown in FIG. 4.

In this case, the switching handle 50 comprises a base 51, by way of which the switching handle 50 is mounted on the housing 2 so as to be able to pivot. The switching handle 50 comprises a crank pin 52 that is carried by the base 51 and by way of which the user is able to actuate the switching handle 50 in rotation by exerting a torque about the handle axis X50. In order to be accessible to the user, the crank pin 52 is arranged at least partially outside the housing 2.

The switching mechanism 40 advantageously comprises a spring, which is referred to as a control spring and is not shown. The control spring applies, to the switching handle 50 and by bearing on the housing 2, a torque about the handle axis X50, which tends to bring the switching handle 50 from its closed position to its open position. For example, the control spring is a helical torsion spring, housed inside the base 51 about the handle axis X50, and one branch of which bears on the switching handle 50 and another branch of which bears on the inside of the housing 2.

The position of the switching handle 50, which is visible from the outside of the housing 2, visually indicates to the user the current configuration commanded for the electrical protection device 1, namely placement of the movable phase contact 11 and the movable neutral contact 21 into the isolating position when the switching handle 50 is in the open position, and placement of the movable phase contact 11 and the movable neutral contact 21 into the conducting position when the switching handle 50 is in the closed position.

The switching mechanism 40 advantageously comprises a connecting rod 42, visible in FIG. 2. The connecting rod 42 connects the switching handle 50 to the rest of the switching mechanism 40. Thus, when the switching mechanism 40 is in the tripped position, the switching handle 50 is in the open position, and when the switching mechanism 40 is in the armed position, the switching handle 50 is in the closed position.

Following one of the tripping devices 30 or 35 detecting an electrical fault of the overload or short-circuit type, one of the tripping devices 30 or 35 commands the switching mechanism 40 into the tripped configuration, the movable phase contact 11 and the movable neutral contact 21 are placed into the isolating position and the switching handle 50 toggles to the open position. The device 1 therefore opens the electrical circuit. A duration T, or delay T, between a moment when the movable phase contact 11 and the movable neutral contact 21 toggle to the isolating position and a moment when the switching handle 50 toggles to the open position, is greater than a duration threshold Tₛ. This duration threshold Tₛ is advantageously of the order of a few milliseconds, for example between 4 and 8 ms, for example equal to 6 ms This delay T is due in particular to the time necessary to move the movable contacts 11 and 21, the switching mechanism 40 and the switching handle 50 following the tripping device 30 or 35 detecting the fault, and to the torque of the springs, in particular the control spring.

By actuating the crank pin 52, a user may then toggle the switching handle 50 from the open position to the closed position, thus causing the movable phase contact 11 and the movable neutral contact 21 to move from the isolating position into the conducting position in order to rearm the device 1 and close the electrical circuit.

In contrast, by actuating the crank pin 52, a user may toggle the switching handle 50 from the closed position to the open position, thus causing the movable phase contact 11 and the movable neutral contact 21 to move from the conducting position into the isolating position, for example to perform operations on the electrical circuit, or to check that the device 1 is operating correctly. In this case, the switching handle 50 passes from the closed position to the open position almost simultaneously with the movable phase contact 11 and the movable neutral contact 21 passing into the isolating position. Almost simultaneous is understood to mean that the duration T between the switching handle 50 passing from the closed position to the open position and the movable phase contact 11 and the movable neutral contact 21 passing into the isolating position is less than the duration threshold Tₛ.

The device 1 further comprises an electrical link element 60, a switch 70, a mechanical link element 80, a current sensor 85 and an electronic control unit 90, which advantageously interact, as described in greater detail below, to determine the position of the movable contacts 11 and 21 and the switching handle 50, and determine the cause of opening of the electrical circuit by the device 1.

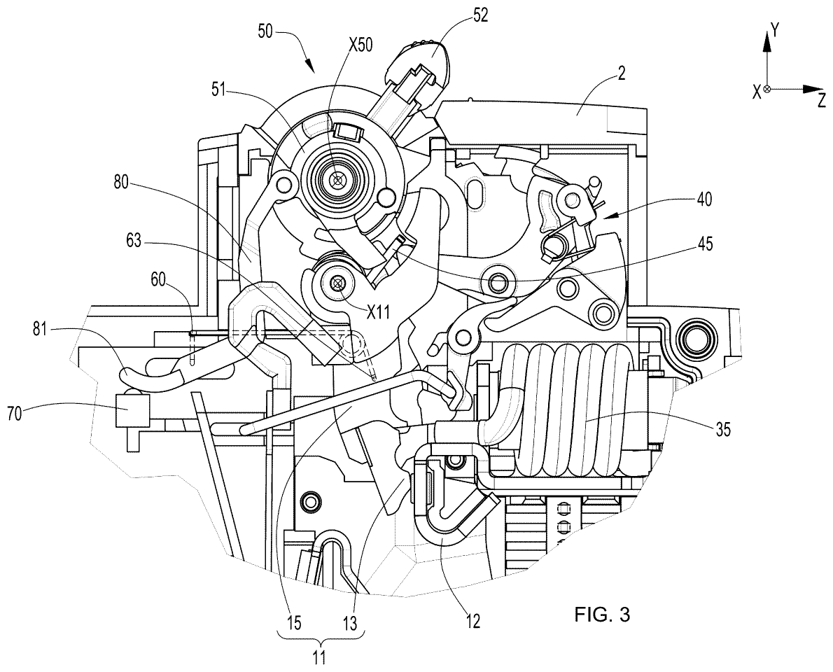

By way of example, the electrical link element 60, which is visible in FIGS. 1 to 4, is a spring and comprises an end 61 and an end 63 opposite to the end 61. The end 61 of the electrical link element 60, which is visible in FIG. 2, is connected to the electronic control unit 90. When the movable phase contact 11 is in the conducting position, the end 63 is in contact with the movable phase contact 11, as shown in FIG. 3, and when the movable phase contact 11 is in the isolating position, the end 63 is separated from the movable phase contact 11, as shown in FIG. 4.

A first voltage V₁ may be measured at the electrical link element 60. If this first voltage V₁ is non-zero, this indicates that the movable phase contact 11 is in a closed state. In contrast, the first voltage V₁ is zero when the movable phase contact 11 is in an open state. In other words, when the movable phase contact 11 is in the conducting position, the first voltage V₁ is non-zero and a current flows from the movable phase contact 11 to the electrical link element 60. When the movable phase contact 11 is in the isolating position, the first voltage V₁ is zero, and no current flows through the electrical link element 60. Thus, the first voltage V₁ is representative of the position of the movable phase contact 11 in the conducting or isolating position.

According to one variant that is not shown, the end of the electrical link element 60 is in contact with the movable neutral contact 21 when the movable neutral contact 21 is in the conducting position, and not the movable phase contact.

The switch 70 is connected to the electronic control unit 90, for example by a wired link. A second voltage V₂ may be measured at the switch 70. The switch 70 is movable between a depressed position, which is visible in FIG. 3, and a free position, which is visible in FIG. 4. The second voltage V₂ varies as a function of the free or depressed position of the switch 70.

By way of example, in the depressed position, the second voltage V₂ is non-zero, that is to say it has a value greater than a predetermined threshold, the threshold being equal, for example, to a few millivolts, and in the free position, the second voltage V₂ is zero, that is to say it has a value less than said predetermined threshold.

Alternatively, the second voltage V₂ is zero when the switch 70 is in the depressed position, and non-zero when it is in the free position. Advantageously, this alternative embodiment makes it possible to reduce energy consumption. Therefore, the second voltage V₂ is representative of the position of the switch 70 between the depressed position and the free position. Preferably, the switch 70 is in the free position by default, so that when no stress is exerted on the switch 70, it remains in the free position.

The mechanical link element 80 is visible in FIGS. 1, 3 and 4. The mechanical link element 80 is connected to the switching handle 50, more precisely to the base 51, so as to be movable at the same time as the switching handle 50.

In one embodiment, shown in the figures, the mechanical link element 80 is a link rod. In a variant, the mechanical link element 80 could be produced in another form, for example a rotating plate, a translating slide, or else a belt. One end 81 of the mechanical link element 80 faces the switch 70 along the Y axis, and is movable between a pressing position and a releasing position. In the pressing position, which is visible in FIG. 3, the end 81 presses the switch 70 in a direction opposite to the Y direction and holds it in the depressed position. In the releasing position, which is visible in FIG. 4, the end 81 no longer presses the switch 70, which is then in the free position.

The mechanical link element 80 is therefore in the pressing position when the switching handle 50 is closed and in the releasing position when the switching handle 50 is open. In an alternative that is not shown, the mechanical link element is in the pressing position when the switching handle is open and in the releasing position when the switching handle is closed. Therefore, the second voltage V₂ is representative of the position of the switching handle 50 between the closed position and the open position.

The current sensor 85 is housed inside the housing 2. The current sensor 85 is configured to measure an intensity I of the current flowing through the device 1.

The electronic control unit 90 is housed inside the housing 2, one part of the electronic control unit being visible in FIG. 1 and the other part being visible in FIG. 2. In the embodiment illustrated in the figures, the electronic control unit 90 is an electronic card. In a variant, the electronic control unit 90 may be produced in a form other than an electronic card, for example in the form of a dry contact connected to a wired data concentrator. The electronic control unit 90 is configured to determine a cause of opening of the electrical circuit, between a manual opening, i.e. caused by a user who toggles the switching handle 50 from the closed position to the open position, and a fault opening, caused by one of the tripping devices 30 or 35. Advantageously, the electronic control unit 90 comprises a memory that is configured to continuously record a value of the intensity I of the current, and in particular to record the value of the intensity I of the current before any opening of the electrical circuit. In other words, the electronic control unit 90 makes it possible to store a value of the current I just before any opening of the device.

When the device 1 is in operation, the electronic control unit 90 measures the first voltage V₁ and the second voltage V₂, and compares the first voltage V₁ with a first voltage threshold Vₛ₁ and the second voltage V₂ with a second voltage threshold Vₛ₂, in order to determine, upon the electrical circuit opening, if this opening is caused by manual opening or fault opening. The electronic control unit 90 is also configured to send a first signal if the cause of opening is manual opening and a second and/or third signal if the cause of opening is fault opening.

Particularly advantageously, the electronic control unit 90 is configured to send the second signal when the tripping device 30 is responsible for opening the electrical circuit, and to send the third signal when the tripping device 35 is responsible for opening the electrical circuit.

The signals are, for example, signals sent wirelessly to a man-machine interface, which is not shown and which displays to the user the cause of opening of the electrical circuit by the device 1. Advantageously, additional information relating to the cause of opening is also displayed. For example, if the first signal is sent, the man-machine interface simply displays manual opening, but if the second or third signal is sent, the man-machine interface displays, for example, the type of electrical fault and/or steps to be taken to check that the electrical fault does not persist in the electrical circuit.

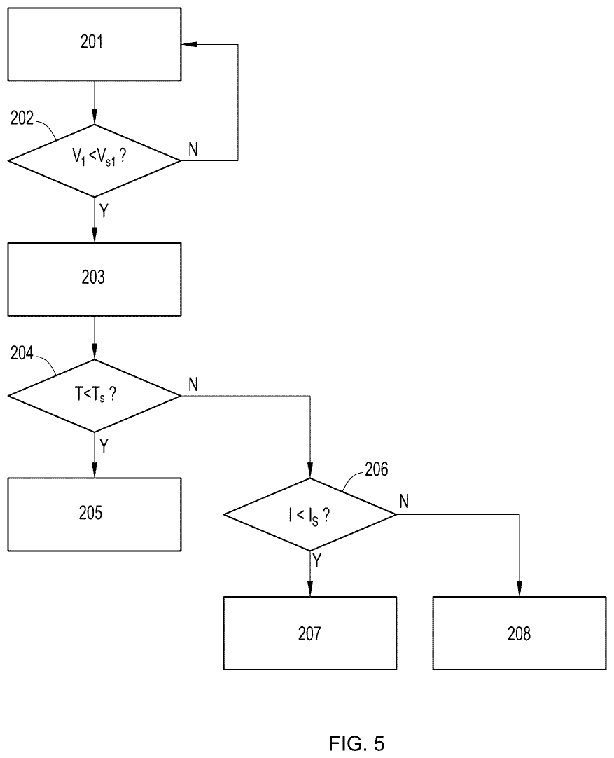

A method for automatically determining the cause of opening of the electrical circuit is described in more detail below with reference to FIG. 5. The method comprises a step 201 of measuring the first and second voltages V₁ and V₂. The measurement is carried out by the electronic card 90. The measurement step 201 is, for example, performed with a frequency equal to or greater than the frequency of the input current of the device 1 (for example 50 Hz in France).

The method also comprises comparing 202 the first voltage V₁ with the first voltage threshold Vₛ₁. If the first voltage V₁ has a value greater than or equal to the first voltage threshold Vₛ₁, the method returns to step 201. This corresponds to a situation where the electrical circuit is closed.

If the first voltage V₁ has a value lower than the first voltage threshold Vₛ₁, this means that the movable phase contact 11 is in the isolating position, and therefore that the device 1 has opened the electrical circuit. A step 203 is then performed, and consists of measuring the duration T between a moment when the first voltage V₁ falls below the first voltage threshold Vₛ₁, corresponding to the moment when the movable phase contact 11 toggles to the isolating position, and a moment when the second voltage V₂ falls below the second voltage threshold Vₛ₂, corresponding to the moment when the switching handle 50 toggles to the open position.

The method further comprises comparing 204 the duration T measured in step 203 with the duration threshold Tₛ. If the duration T is less than the duration threshold Tₛ, then the switching handle 50 and the phase contact 11 have been moved almost simultaneously, which corresponds to manual opening.

In this case, a step 205 is performed, in which the electronic control unit 90 sends the first signal. This first signal is advantageously received by the man-machine interface in order to generate a display indicating to the user that the cause of opening is manual opening.

If the duration T is greater than or equal to the duration threshold Tₛ, then the switching handle 50 has been moved after the movable phase contact 11 passed into the isolating position, which corresponds to fault opening.

In this case, advantageously, a step 206 is performed, in which the intensity I of the current measured by the current sensor 85 before opening of the device 1 and recorded by the memory of the electronic card 90 is compared with a current threshold Iₛ. The current threshold Iₛ is advantageously calculated as a function of a nominal current of the electrical circuit, and is equal to the nominal current flowing through the electrical circuit multiplied by a predetermined value, this value being, for example, equal to three. If the nominal current of the electrical circuit is 32 A, then the current threshold Iₛ is, for example, 96 A.

If the intensity I of the current before opening of the device 1 is less than the current threshold Iₛ, then a step 207 is performed, step 207 consisting of the electronic control unit 90 sending the second signal. This second signal is advantageously received by the man-machine interface in order to generate a display indicating to the user that the cause of opening is fault opening following a current overload in the electrical circuit.

If the value of the intensity I of the current is greater than or equal to the current threshold Iₛ, then a step 208 is performed, consisting of the electronic control unit 90 sending the third signal. This third signal is advantageously received by the man-machine interface in order to generate a display indicating to the user that the cause of opening is fault opening following a short circuit in the electrical circuit.

The recording of the intensity I of the current by the memory of the electronic card 90 thus makes it possible, in the event of fault opening of the device 1, to determine the cause of the fault between a current overload and a short circuit.

In a variant that is not shown, if the duration T is greater than or equal to the duration threshold Tₛ, steps 206 and 207 are not performed, and a step corresponding to sending the second signal is performed instead. In this case, the second signal corresponds to fault opening, without specifying the nature of the fault.

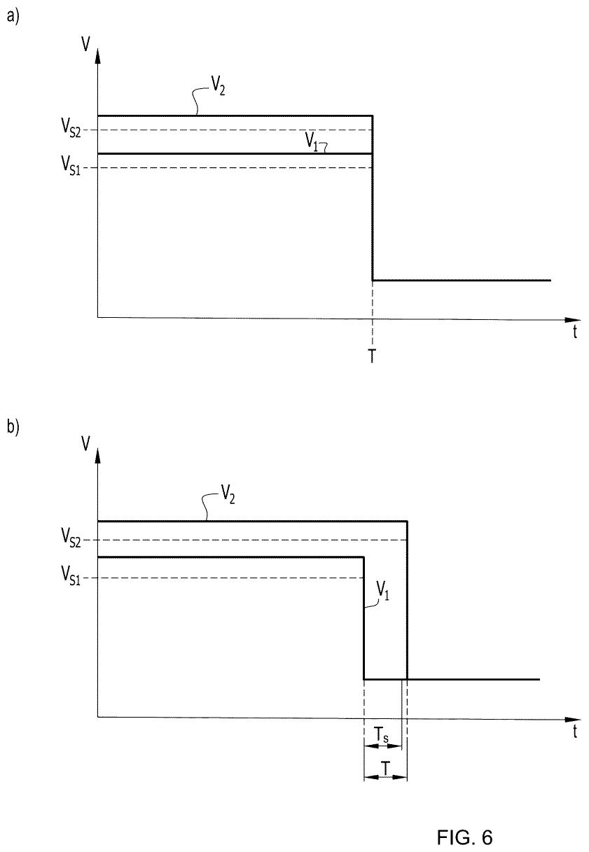

FIG. 6 shows a variation of the first and second voltages V₁ and V₂ in the case of manual opening and in the case of fault opening. In insert a) of FIG. 6, representing manual opening, the voltages V₁ and V₂ decrease at the same time. Thus, the duration T between the moment when the first voltage V₁ has fallen below the first voltage threshold Vₛ₁ and the moment when the second voltage V₂ falls below the second voltage threshold Vₛ₂ is less than the duration threshold Tₛ. In insert b) of FIG. 6, corresponding to fault opening, the duration T between the moment when the first voltage V₁ has fallen below the first voltage threshold Vₛ₁ and the moment when the second voltage V₂ falls below the second voltage threshold Vₛ₂ is greater than the duration threshold Tₛ.

In FIG. 5, the first voltage V₁ is shown as being greater than the second voltage V₂. According to other variants that are not shown, the first voltage V₁ is lower than the second voltage V₂, or equal to the second voltage V₂.

Alternatively, rather than measuring a first voltage V₁ and a second voltage V₂, and comparing them with the first voltage threshold Vₛ₁ and with the second voltage threshold Vₛ₂, respectively, the electronic control unit 90 measures a first and a second current and compares them with a first current threshold and with a second current threshold.

According to a variant that is not shown, a fourth signal, corresponding to an absence of current upstream of the device 1, is transmitted when the first voltage is less than the first voltage threshold and the second voltage remains greater than the second voltage threshold for a duration greater than a network fault duration threshold that is greater than the duration threshold Tₛ. Specifically, when there is no current upstream of the device, the first voltage becomes zero, but this is not caused by the movable phase contact being moved into the isolating position. As a result, the handle does not toggle to the open position. This makes it possible to distinguish an absence of current due to an interruption upstream of the device from an electrical fault in the electrical circuit.

Particularly advantageously, the second and/or third signals are sent only once the network fault duration threshold has been reached, in order to avoid sending the second and/or the third signal once the duration threshold has been reached, and sending the fourth signal once the network fault duration threshold has been reached, which could lead to confusion as to the nature of the fault detected by the device.

The electrical link element 60, the switch 70, the mechanical link element 80, the current sensor 85 and the electronic control unit 90 together perform a functionality called “open closed fault signal”, which allows the user to identify the cause of opening of the electrical circuit between a manual cause and a fault cause, and advantageously, in the event of an electrical fault, to also know what type of electrical fault generated opening of the circuit. This facilitates remote control of the device 1, in particular to determine whether or not it is necessary to intervene following an electrical fault.

Advantageously, the elements used to automatically determine the cause of opening and their arrangement make it possible to maintain the compactness of the protection device 1, in particular in the width direction X. In particular, the housing 2 may have a width, measured in the width direction X, of less than 20 mm, preferably equal to 18 mm.

Any feature described for one embodiment or one variant in the above text may be implemented for the other embodiments and variants described above, as long as this is technically feasible.

1. An electrical protection device that is designed to be connected between an input conductor and an output conductor of an electrical circuit, and to open the electrical circuit upon manual command or following detection of an electrical fault, the device being further configured to automatically determine a cause of opening of the electrical circuit, the device comprising:
a movable contact that is connected to the electrical circuit and is movable between:
a conducting position, in which the movable contact closes the electrical circuit, and
an isolating position, in which the movable contact opens the electrical circuit;
a switching handle that is movable between an open position and a closed position, the movement of the switching handle to the open position by manual control causing the movable contact to be placed into the isolating position;
a switching mechanism that is configured to toggle between an armed configuration, in which the movable contact is in the conducting position and the switching handle is in the closed position, and a tripped configuration, in which the movable contact is in the isolating position and the switching handle is in the open position;
a tripping device that is configured to actuate the switching mechanism in the event of detecting an electrical fault to command the tripped configuration;
an electronic control unit;
wherein the device further comprises:
an electrical link element that connects the movable contact and the electronic control unit, and is configured so that a first current flows through the electrical link element to the electronic control unit, a first voltage being representative of the position of the movable contact in the conducting position or in the isolating position;
a switch that is connected to the electronic control unit and is movable between a depressed position and a free position, and is configured so that a second current flows through the switch to the electronic control unit, a second voltage being representative of the position of the switch between the depressed position and the free position;
a mechanical link element that is connected to the switching handle and movable between:
a pressing position, the mechanical link element then pressing the switch and holding it in the depressed position, and
a releasing position, the mechanical link element then releasing the switch which toggles to the free position,
and wherein the electronic control unit is configured to measure the first voltage and the second voltage, compare the first voltage and the second voltage to determine the cause of opening of the electrical circuit among manual opening and fault opening, send a first signal if the cause of opening is manual opening and send a second and/or third signal if the cause of opening is fault opening.

2. The device according to claim 1, wherein the movable contact is a movable phase contact.

3. The device according to claim 1, wherein the mechanical link element is in the pressing position when the switching handle is in the closed position and in the releasing position when the switching handle is in the open position.

4. The device according to claim 1, wherein the electrical link element is a spring that is in contact with the movable contact when the movable contact is in the conducting position and is separated from the movable contact when the movable contact is in the isolating position, one of the ends of the electrical link element being connected to the electronic control unit.

5. The device according to claim 1, wherein the mechanical link element is a link rod that is connected to the switching handle, and one end of which is configured to press or release the switch.

6. The device according to claim 1, further comprising a thermal tripping device and/or a magnetic tripping device that is configured to toggle the movable contact from the conducting position to the isolating position when the thermal tripping device and/or the magnetic tripping device are/is excited by an electrical fault of short-circuit or overload type.

7. The device according to claim 1, the device being integrated into a housing, the housing having a width, measured in a width direction, of less than 20 mm, preferably equal to or less than 18 mm.

8. A method for automatically determining a cause of opening of an electrical circuit, the method being implemented by a device according to claim 1, the method comprising:
measuring the first voltage and the second voltage;
comparing the first voltage with a first voltage threshold;
when the first voltage falls below the first voltage threshold, measuring a duration between a moment when the first voltage falls below the first voltage threshold, and a moment when the second voltage falls below a second voltage threshold;
comparing the duration with a duration threshold;
sending the first signal when the duration is less than the duration threshold, the first signal corresponding to manual opening;
sending the second signal and/or the third signal when the duration is greater than or equal to the duration threshold, the second signal and/or the third signal corresponding to fault opening.

9. The method according to claim 8, comprising sending the second signal when the duration is greater than or equal to the duration threshold and when an intensity value of a current is less than a current threshold, the method further comprising sending the third signal when the duration is greater than or equal to the duration threshold and the intensity value of the current is greater than or equal to the current threshold.

10. The method according to claim 8, wherein the duration threshold is less than 10 ms.

11. The method according to claim 8, wherein the current threshold is equal to a nominal current flowing through the electrical circuit multiplied by a predetermined value, for example three.

12. The method according to claim 8, further comprising sending a fourth signal when the duration is greater than or equal to a network fault duration threshold, the network fault duration threshold being greater than the duration threshold.

13. The device according to claim 7, wherein the width of the housing is equal to or less than 18 mm.

14. The method according to claim 10, wherein the duration threshold is equal to 6 ms.

15. The method according to claim 11, wherein the predetermined value is three.
